(19) United States
(12) Patent Application Publication
(10) Pub. No.: US 2021/0135947 A1
(43) Pub. Date: May 6, 2021

(54) LOW-LATENCY AND HIGH-BANDWIDTH DATA CABLE

(71) Applicant: Inflection Point Technology, LLC, Silver Spring, MD (US)

(72) Inventor: Richard Hansen, Silver Spring, MD (US)

(21) Appl. No.: 17/088,868

(22) Filed: Nov. 4, 2020

Related U.S. Application Data
(60) Provisional application No. 62/930,317, filed on Nov. 4, 2019.

(51) Int. Cl. H04L 12/24; H01B 11/12; H01B 11/18

(52) U.S. Cl. CPC H04L 41/0896; H01B 11/183; H01B 11/12

(57) ABSTRACT

A data cable compatible with twisted-pair standards and equipment uses separate coaxial wires with unique dielectric properties to transmit each of the signals and provide lower latency, greater bandwidth, and lower loss. This design addresses the latency issues that limit the physical size of supercomputers and can be significant for high-performance computing projects, cryptocurrency mining, high-frequency trading, and other time-sensitive applications via the use of a dielectric with a low refractive index and physical design that meets specifications for ethernet cables. The design provides for flexibility in overall shielding and the connections of shields for individual elements to address the likelihood of electromagnetic interference in an environment. The dimensions and choice of dielectric can be modified to provide higher velocity factors and/or greater bandwidth.

### CROSS-REFERENCE TO RELATED APPLICATIONS

This application claims the benefit of U.S. Provisional Patent Application No. 62/930,317, filed Nov. 4, 2019, the entire contents of which are incorporated herein by reference.

### TECHNICAL FIELD

The present disclosure relates to cables used for transmitting and receiving data for computer networks and point-to-point connections between computing devices.

### BACKGROUND

Some computing devices communicate via Ethernet over twisted pair cables. These cables typically use eight wires to provide a path for signal transmission at data rates of 1 Gigabit per second (Gbps) or higher. Cables are typically constructed using four pairs of wire, with each wire covered by insulation. The wires are paired, with each pair of wires being twisted together across the length of the cable. A typical cable used for data communications uses twisted-pair cable for data transmission, such as four twisted-pairs of wire to transmit data at high speed, which is the basis for modern twisted-pair Ethernet cables. The four pairs may or may not be enclosed by a cylindrical conductive shield, typically constructed of metal foil, metalized polyester or plastic, or woven wire. The physical design, spacing between elements, and materials used for insulation determine the cable's propagation delay, which is defined as the time it takes an electrical signal to travel a unit length. This may also be expressed as a Velocity Factor, which expresses the time it takes to travel a unit length of the cable as a percentage of the speed of light. The most commonly used twisted-pair Ethernet cables, Category (or Cat) 5e, Cat 6, and Cat 6A have a velocity factor of 65%-70%. The latency, or delay, in the time it takes for data to be transmitted from one device to another device is inversely proportional to the velocity factor. These delays limit the physical size of supercomputers and can be significant for high-performance computing projects, cryptocurrency mining, high-frequency trading, and other time-sensitive applications.

The maximum amount of data that can be sent over a specified length cable in a unit of time is related to the cable's bandwidth, which is defined as the range of frequencies that may travel over a cable of specified length with enough power remaining to be useful. This loss, called attenuation, becomes greater as the frequencies and bandwidth become higher. Twisted pair data cables are rated on a Category (or Cat) system, where Cat 5e has 100 MHz bandwidth, Cat 6 has 250 MHz bandwidth, Cat 6A has 500 MHz bandwidth, and Cat 7 has 600 MHz bandwidth. Increasing the bandwidth to 2 GHz, which will be required for the upcoming Cat 8 standard, presents challenges for manufacturers. A cable with higher bandwidth will allow the rate that data is sent to increase, reducing the time needed to transmit a given quantity of data out of a system.

One method to increase the bandwidth of an Ethernet cable includes pairs of conductors enclosed within multiple layers of shielding, also called twinax cable, to increase the data rate for Ethernet cabling. This does not increase the velocity of propagation, and encloses pairs of conductors sharing a common dielectric, shield, and outside insulation.

### BRIEF DESCRIPTION OF THE DRAWINGS

FIG. 1 is a system block diagram showing components of data connection using a data cable according to an example embodiment.

FIG. 2A is a cross section of a data cable according to one example embodiment.

FIG. 2B is a cross section of a data cable according to another example embodiment.

FIG. 3A is a top view of an example connector using a data cable according to an example embodiment.

FIG. 3B is a bottom view of the example connector shown in FIG. 3A.

FIG. 4 is a graph illustrating the performance of the data cable according to an example embodiment.

### DESCRIPTION OF EXAMPLE EMBODIMENTS

### Overview

The techniques presented herein describe the use of copper- or other conductive material-based (e.g., plated steel) cable for data transmission. In an embodiment, the cable is an improved low-latency and high-bandwidth data cable for Ethernet data transmission that uses eight individual coaxial wires, each coaxial wire with an outer conductor (also referred to herein as the shield or shield layer) separated from a center conductor by an insulating medium (also referred to herein as the dielectric or dielectric layer).

In one embodiment, a set of eight coaxial wires is packaged to create a concentric, rectangular, or flat arrangement to provide a desired form factor for a particular installation. For each coaxial wire, the parts are preferably arranged concentrically. The center conductor of each coaxial wire may be stranded wire, hollow wire, or solid wire, and may be supported by a nonconductive thread. The shield layer of each coaxial wire is preferably a tubular member formed of a conductive material, such as a metallized polyester, a metal mesh, woven wires, or a braided metal. The shield layer preferably completely encloses the inner conductor, and may be cylindrical, rectangular in cross-section, or have another polygon shape in cross-section to meet a desired form factor. The dielectric material between the shield and center conductors of the coaxial wires may have a refractive index of 1.25 or less, such as air, a non-reactive gas, a closed-cell foam, or other material with the desired characteristics. If air or a non-reactive gas is used, the center conductor may be held in place by a spacer, such as a nonconductive thread. Additional shielding, such as metallized polyester, metal mesh, or braided metal, may be used to enclose pairs of coaxial wires in accordance with the American National Standards Institute/Telecommunications Industry Association (ANSI/TIA) 568 specification, and/or to enclose the entire set of coaxial wires. The use of a separate coaxial wire for each signal reduces attenuation, allowing for bandwidths greater than 1 GHz.

### DETAILED DESCRIPTION

Ethernet over twisted pair uses four pairs of wires, with each pair using differential voltages to transmit data. The data cable described herein uses coaxial wires instead of twisted pairs. In an embodiment, pairs of coaxial wires may have their shield conductors connected at one or more places on a cable. In another embodiment, all shield conductors of the coaxial wires may be connected together at one or more places on a cable, or connect them to an external conductive point.

In operation the data cable described herein may be installed and treated as any other copper-based or electrically conductive Ethernet cable. Registered Jack 45 (RJ45) connectors may be connected to the data cable, as specified in ANSI/TIA 568, or other connectors in accordance with the Small Form-factor Pluggable (SFP), Quad Small Form-factor Pluggable (QSFP), or other relevant standard for higher data rates. As with typical copper or optical cable, the data cable described herein may be installed on a path that respects the physical limits for strength and bend radius. The data cable may be connected to devices or equipment at both ends and data may be transmitted with no need for special configuration or accommodations to the devices.

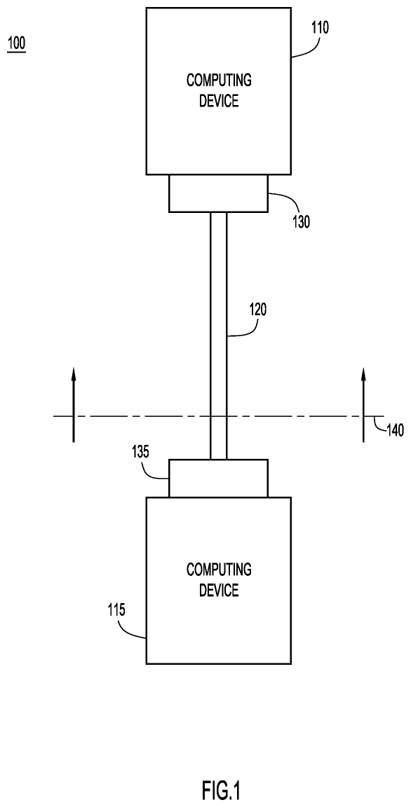

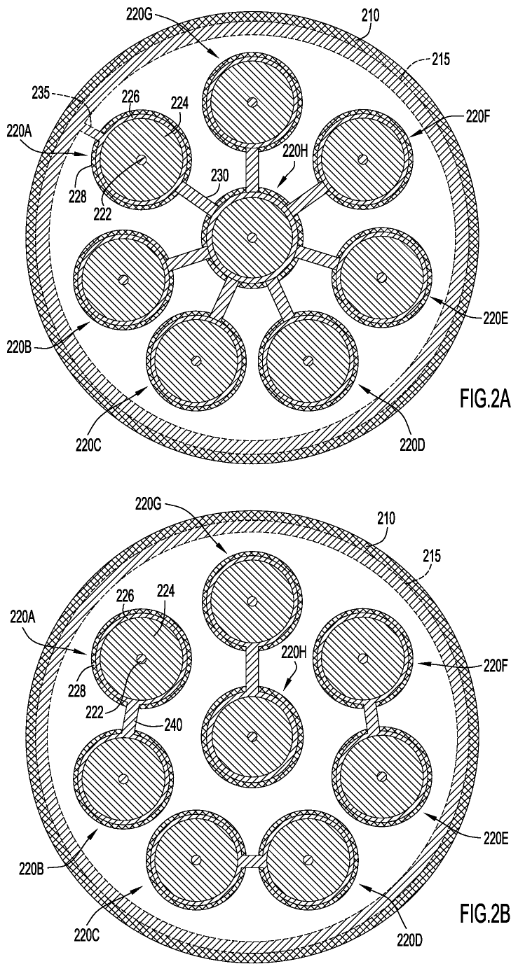

Referring now to FIG. 1, a data communication system 100 is shown. The system 100 includes computing devices 110 and 115 coupled to each other through data cable 120. The data cable 120 may include connectors 130 and 135 to connect to the computing devices 110 and 115, respectively. A cross-section 140 of the data cable 120 is depicted in FIG. 1, and will be described hereinafter with respect to FIG. 2A and FIG. 2B.

In one example, the computing device 110 and/or computing device 115 may be any type of computing device (e.g., a laptop computer, desktop computer, server, Internet of Things (IoT) device, etc.) that is configured to process data that is transmitted and/or received through the data cable 120. Alternatively, the computing device 110 and/or computing device 115 may be a network device (e.g., switch, router, etc.) that is configured to convey data to/from the data cable 120, and may or may not process the data before forwarding the data to another network device or computing device.

In another example, the connectors 130 and 135 may be the same or different types of connectors that are configured to securely attach the data cable 120 to the computing device 110 or 115. For instance, the connector 130 and/or connector 135 may be an RJ45 connector that is typically used for connecting computing devices that communicate using the Ethernet standard. Alternatively, other standard or custom connectors may be used to couple the data cable 120 to the computing device 110 and/or computing device 115.

In a further example, the data cable 120 may be a unitary cable surrounded by a cable housing, such as a layer of electrically insulating material. Alternatively, the data cable 120 may include multiple individual coaxial wires, which are individually surrounded by an electrically insulating layer. The individual coaxial wires may be coupled to each other for a substantial portion of the length of the data cable 120, e.g., coupled with adhesive to a flexible center support. Alternatively, the individual coaxial wires may be intermittently coupled to each other or to a supporting structure, e.g., with a clip or other fastening device. For instance, the data cable 120 may be configured to enable the individual coaxial wires to lay flat along the length of the data cable 120 by clipping the individual coaxial wires to a support frame for the computing device 110 or 115.

Referring now to FIG. 2A and FIG. 2B, two examples of a cross-section 140 of data cable 120 are shown. Data cable 120 includes an outer insulation layer 210 of tubular configuration made of an electrically insulating material, such as a flexible plastic material, that provides structural support and electrical isolation to the data cable. Optionally, an outer shield layer 215 formed of an electrically conductive material may be disposed radially inward of the outer insulation layer 210 to provide additional electrical isolation. In an example embodiment, the optional outer shield layer 215 may be a tubular member formed of a conductive material, such as a metallized polyester or plastic, a metal mesh, a woven wire, or a braided metal. Disposed within the outer insulation layer 210 and, optionally the outer shield layer 215, the data cable includes eight coaxial wires 220A-220H.

The coaxial wire 220A includes a center conductor 222 surrounded by a dielectric layer 224. The center conductor 222 may be stranded wire, hollow wire, or solid wire, and may be supported by a nonconductive thread. An electrically conductive coaxial wire shield layer 226 surrounds the dielectric layer 224, and a coaxial wire insulation layer 228 surrounds the coaxial wire shield layer 226. The shield layer 226 is preferably a tubular member formed of a conductive material, such as a metallized polyester or plastic, a metal mesh, woven wires, or a braided metal. The insulation layer 228 may be a tubular member made of an electrically insulating material, such as a flexible plastic material. Each of the coaxial wires 220B-220H preferably include features (e.g., center conductor dielectric layer, shield layer, insulation layer) corresponding to the features of the coaxial wire 220A.

In one example, the dielectric layer 224 in the coaxial wires 220B-220H may have a low index of refraction (e.g., 1.25 or less) to provide a velocity factor of greater than or equal to 80%. For instance, the low index of refraction insulation may be air or a non-reactive gas with spacers (such as nonconductive threads) to hold the center conductor, closed-cell foam, or other material with the desired characteristics. The individual coaxial wires 220A-220H may be physically bound together in a concentric, rectangular, or flat arrangement to provide the desired form factor for a particular installation.

In the embodiment depicted in FIG. 2A, a conductive link 230 connects the shield layer 226 to a corresponding shield layer for coaxial wire 220H. Optionally, the shield layer 226 of the coaxial wire 220A may be electrically coupled to the outer shield layer 215 through a conductive link 235. Additional conductive links also connect the shield layers of the coaxial wires 220B-220G to the shield layer of the coaxial wire 220H, ensuring that all of the shield layers for the individual coaxial wires 220A-220H are electrically connected at the same potential. The optional link 235 to the outer shield layer 215 may also be replicated for one or more other coaxial wires 220B-220H. In an example embodiment, conductive links 230 and 235 may be conductive wires soldered between shield layers. Alternatively, the conductive links may be solder joints between shield layers. In another example, the conductive links between the coaxial wires 220A-220H, and optionally the outer shield layer 215, may be simple voids in the insulation layer of each coaxial wire, enabling all of the shield layers to be electrically coupled.

In the embodiment depicted in FIG. 2B, a conductive link 240 electrically couples the shield layer 226 of the coaxial wire 220A with the corresponding shield layer of the coaxial wire 220B. Similarly, conductive links electrically couple the shield layers of coaxial wires 220C and 220D, coaxial wires 220E and 220F, and coaxial wires 220G and 220H. This configuration of four pairs of coaxial wires with electrically linked shield layers may correspond to the pairs of wires used for communicating according to Ethernet standards.

In one example of the embodiments depicted in either FIG. 2A or FIG. 2B, the conductive links (e.g., conductive link 230, 235, and/or 240) may run some or all of the length of the data cable 120. Alternatively, the conductive links between the coaxial wires, and optionally the outer shield layer, may be made at one or both ends of the data cable 120, but not the entire length of the data cable 120. The conductive links between shield layers may be made by soldering, crimping, pressing, welding, or any other suitable method for electrically coupling the shield layers. In another example, the shield layers of the coaxial wires may be left unconnected from the shield layers of other coaxial wires.

The embodiments depicted in FIG. 2A and FIG. 2B include eight wires arranged in a circular configuration, but the data cable may be used in other configurations (e.g., flat, rectangular, etc.) and may include more or fewer coaxial wires.

The physical properties and proportions of elements of each wire in the data cable may be designed to provide an acceptable match for the 100Ω impedance and the capacitance per unit length specified for Ethernet cables. Alternatively, the wires in the data cable may be designed to match any impedance value, e.g., as specified for a high speed data cable. The center conductors of the constituent coaxial wires may be connected in pairs as specified in the ANSI/TIA 568 specification. The shields of coaxial wires treated as pairs may be connected at one or more locations for each pair. Alternatively, all eight coaxial wires may have all their shields joined together at one or more locations. Pairs of coaxial wires may also be enclosed by metallized polyester tape or other conductive material for additional shielding.

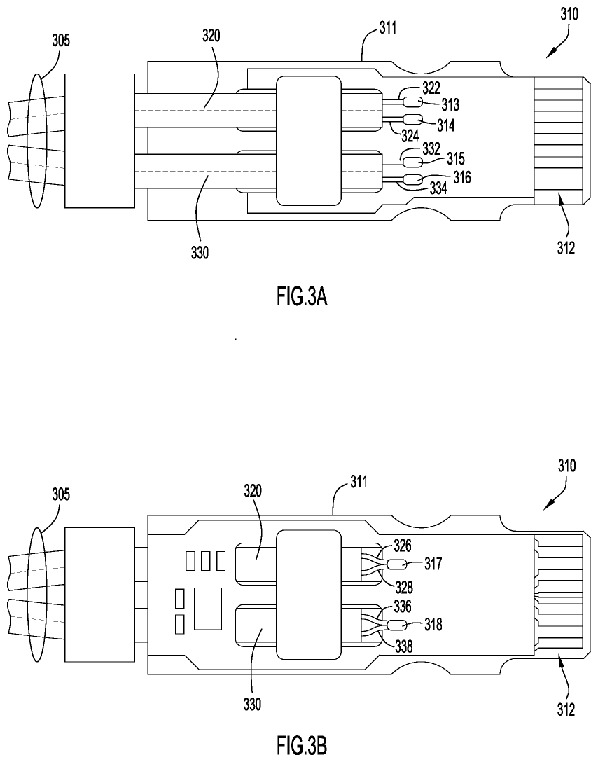

Referring now to FIG. 3A and 3B, an example is shown of a connector 310 for the data cable 305 fabricated according to the techniques described herein. A top view of the connector 310 is shown in FIG. 3A and a bottom view of the connector 310 is shown in FIG. 3B. The connector 310 in FIG. 3A and FIG. 3B is shown as an SFP connector, but other types of connectors (e.g., RJ45) may be used with a data cable according to the techniques described herein. Additionally, the SFP connector 310 is shown without an external housing to enable visibility into the connections of the data cable 305 to the connector 310.

The connector 310 includes a substrate 311, such as a printed circuit board, with contacts 312 configured to couple to a computing device. On the top side of the circuit board 311, as shown in FIG. 3A, contact pads 313, 314, 315, and 316 are configured to provide an electrical connection to the center conductors of the coaxial wires in the data cable 305. On the bottom side of the circuit board 312, as shown in FIG. 3B, contact pads 317 and 318 are configured to provide an electrical connection to the shields of the coaxial wires in the data cable 305.

The connector 310 holds a data cable 305 comprising a first pair of coaxial wires 320 and a second pair of coaxial wires 330. The first pair of coaxial wires 320 includes center conductors 322 and 324 that are connected to the contact pads 313 and 314, respectively, as shown in FIG. 3A. In one example, the center conductors 322 and 324 may be soldered to pads 313 and 314, which are connected to contact traces in the substrate 311 of the connector 310. The shield conductors 326 and 328 for the first pair of coaxial wires 320 are both connected to the contact pad 317 on the bottom side of the substrate 311. Similarly, the second pair of coaxial wires 330 includes center conductors 332 and 334 that are connected to the contact pads 315 and 316, respectively, as shown in FIG. 3A. The shield conductors 336 and 338 of the second pair of coaxial wires 330 are both connected to the contact pad 318 on the bottom side of the substrate 311.

In one example, the connector 310 may include one or more perforations in the substrate 311 to allow the shield conductors 326 and 328 to couple to the contact pad 317 on the bottom side of the substrate 311. The embodiment shown in FIG. 3A and FIG. 3B describes the center conductors 322, 324, 332, and 334 being connected on opposite sides of the substrate 311 to the shield conductors 326 and 336. However, in other embodiments, the center conductors and shield conductors may be connected to the same side of the substrate in a connector. Alternatively, one or more pairs of coaxial wires may be attached to the connector on one side of the substrate, while one or more other pairs of coaxial wires may be attached to the connector on the opposite side of the substrate.

In another example, the first pair of coaxial wires 320 and/or the second pair of coaxial wires 330 may include two coaxial wires that are joined to each other along a majority of the data cable 305. Alternatively, the first pair of coaxial wires 320 and/or the second pair of coaxial wires 330 may include separate coaxial wires which are completely separate outside of the connector 310.

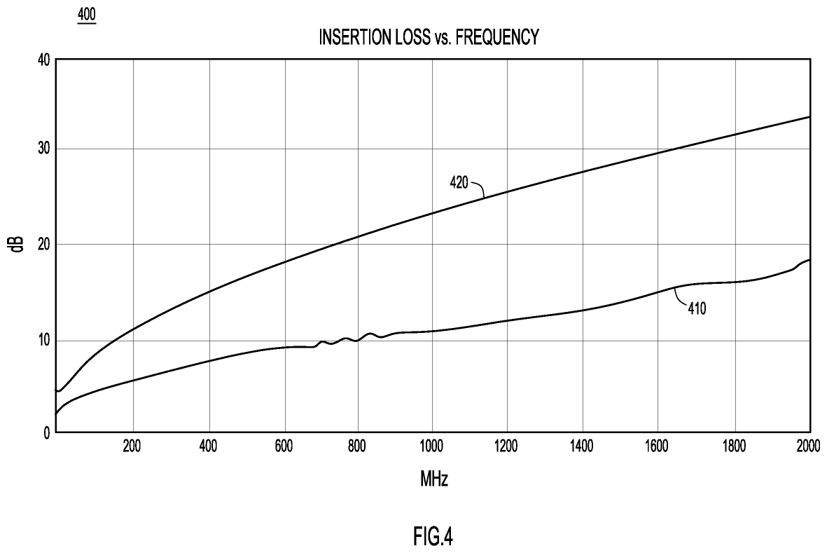

Referring now to FIG. 4, a graph 400 illustrates the signal loss of a one example of a data cable according to the techniques presented herein. The graph 400 shows the measured insertion loss at the maximum length allowed for a conventional Cat 8 cable, i.e., 100 feet, across a 2 GHz bandwidth. The insertion loss for the data cable described herein is shown by line 410, and is shown in comparison to the insertion loss for a conventional Cat 8 cable, as shown in line 420. As the line 410 shows, the data cable according to the techniques described herein produces approximately half of the loss measured in dB that a conventional Cat 8 cable produces. The data cable described herein provides sufficient signal strength to meet the Cat 8 standard for a cable that is almost twice as long as the Cat 8 standard allows.

The insertion loss data shown in FIG. 4 was measured with a Fluke® DSX-8000 cable analyzer calibrated to a National Institute of Standards and Technology (NIST) standard. Similar testing shows that a data cable constructed according to the techniques described herein meets the insertion standards for a Cat 6A cable at up to 600 feet, which is almost twice the length of the allowed length of a conventional data cable according to the Cat 6A standard.

The data cable described herein enables advantages in comparison to typical twisted pair data cables. In one advantage, the velocity of signals transmitted through the data cable described herein is higher than the velocity of signals transmitted through traditional twisted-pair cables. Traditional twisted-pair cables (e.g., Cat 6A cables) as well as fiber optic data cables typically have a Velocity Factor of 65-70%. In contrast, the data cable as described herein has a Velocity Factor that has been measured up to 85%, enabling a lower propagation delay and a higher velocity of propagation. Additionally, the data cable described herein has greater bandwidth due to the lower attenuation unit length compared to twisted pair data cable. Data arrives sooner when crossing improved data cable described herein and higher quantities of data may be sent in a unit time.

In summary, the techniques presented herein provide for a data cable which can transmit Ethernet and other electrical signals with a Velocity Factor of 80% or greater and higher and a bandwidth of 1 GHz or higher. In one example, the data cable includes eight connections on each end that may be used to transmit Ethernet signals in a manner compatible with the use of existing Cat 5e/6/6a/7/8 cables, an external insulating jacket, and an optional shield around all eight coaxial wires. The eight constituent coaxial wires may use a dielectric material with an index of refraction of 1.25 or less, and the shields of the coaxial wires may be connected in pairs or across all of the wires. The data cable described herein enables network-compatible devices and equipment to be connected to each end in fashion compatible with the ANSI/TIA 568 specification and experience the benefits of lower latency, lower loss, and improved bandwidth.

The use of a separate coaxial wires with unique dielectric properties to transmit each of the eight signals provides lower latency, lower loss, and greater bandwidth. This design addresses the latency issues that limit the physical size of supercomputers and can be significant for high-performance computing projects, cryptocurrency mining, high-frequency trading, and other time-sensitive applications via the use of a dielectric with a low refractive index and physical design that meets specifications for Ethernet cables. The design provides for flexibility in overall shielding and the connections of shields for individual elements to address the likelihood of electromagnetic interference in an environment. The dimensions and choice of dielectric can be modified to provide higher velocity factors and/or greater bandwidth.

The above description is intended by way of example only.

What is claimed is:

1. A data cable comprising:
a plurality of coaxial wires including a first coaxial wire and a second coaxial wire wherein each coaxial wire in the plurality of coaxial wires comprises a center conductor and an electrically conductive shield layer separated by a dielectric layer,
wherein a first shield layer of the first coaxial wire is electrically coupled to a second shield layer of the second coaxial wire.

2. The data cable of claim 1, wherein the dielectric layer has a refractive index less than or equal to 1.25.

3. The data cable of claim 1, further comprising an electrically conductive outer shield layer surrounding the plurality of coaxial wires.

4. The data cable of claim 1, further comprising a connector adapted to couple the data cable to a computing device.

5. The data cable of claim 4, wherein the connector is selected from a Registered Jack 45 (RJ45) connector, a Small Form-factor Pluggable (SFP), or a Quad Small Form-factor Pluggable (QSFP) connector.

6. The data cable of claim 4, wherein the center conductor of each of the plurality of coaxial wires is coupled to a first side of the connector, and the electrically conductive shield layer of each of the plurality of coaxial wires in coupled to a second side of the connector.

7. The data cable of claim 1, further comprising an outer layer of electrically insulating material surrounding the plurality of coaxial wires.

8. The data cable of claim 1, further comprising a flexible supporting structure coupled to the plurality of coaxial wires.

9. The data cable of claim 1, wherein the first shield layer of the first coaxial wire is electrically coupled to shield layers of all of the plurality of coaxial wires.

10. The data cable of claim 1, wherein each coaxial wire further comprises a spacer in the dielectric layer holding the center conductor separate from the electrically conductive shield layer.

11. The data cable of claim 1, wherein an insertion loss of the data cable at 100 feet is less than 20 dB across a 2 GHz bandwidth.

12. A method of communicating data between devices, the method comprising:
connecting a data cable between a first computing device and a second computing device, the data cable comprising a plurality of coaxial wires, wherein each coaxial wire in the plurality of coaxial wires comprises a center conductor and an electrically conductive shield layer separated by a dielectric layer having an index of refraction less than or equal to 1.25; and
transmitting data between the first computing device and the second computing device using one or more of the coaxial wires.

13. The method of claim 12, further comprising electrically coupling shield layers of at least two of the coaxial wires to shield the center conductors.

14. The method of claim 12, wherein the data cable includes an outer shield layer enclosing the plurality of coaxial wires.

15. The method of claim 14, wherein the outer shield layer is electrically coupled to a shield layer of at least one of the coaxial wires.

16. The method of claim 12, wherein transmitting data between the first computing device and the second computing device comprises transmitting data across at least 100 feet of the data cable with an insertion loss of less than 20 dB across a 2 GHz bandwidth.

17. The method of claim 12, further comprising disposing the plurality of coaxial wires within a cable housing made of an electrically insulating material.

18. The method of claim 12, further comprising attaching the data cable to a supporting structure between the first computing device and the second computing device.
